(19) United States
(12) Patent Application Publication
(10) Pub. No.: US 2026/0228324 A1
(43) Pub. Date: Aug. 6, 2026

(54) ANOMALY DETECTION TO CLASSIFY INTEGRATED CIRCUIT DEVICES

(71) Applicant: Analog Devices, Inc., Wilmington, MA (US)

(72) Inventors: Stewart Merkel, Dallas, TX (US); Mehmet Gorkem Ulkar, Dallas, TX (US); Carlos Contreras, Dallas, TX (US)

(21) Appl. No.: 19/399,060

(22) Filed: Nov. 24, 2025

Related U.S. Application Data
(60) Provisional application No. 63/725,360, filed on Nov. 26, 2024.

(51) Int. Cl. G06F 21/44; G06N 3/0455

(52) U.S. Cl. CPC G06F 21/44; G06N 3/0455

(57) ABSTRACT

Clone or counterfeit devices can be identified using anomaly detection techniques applied to time series representations of electric signals associated with integrated circuit devices. For example, by analyzing time series electrical waveforms that capture intrinsic device (e.g., semiconductor or circuit) behavior, such techniques can be used to distinguish genuine devices from clones without requiring traditional cryptographic authentication features or associated infrastructure. In addition to, or instead of device authentication, the present subject matter can also be used for anomaly detection in other contexts, such as to detect an indication of anomalous device aging status, or an indication of an anomalous device electrical stress condition.

### CLAIM OF PRIORITY

This patent application claims the benefit of priority of Merkel et al., U.S. Provisional Patent Application No. 63/725,360, titled “AI ANOMALY DETECTION TO IDENTIFY IC DEVICES AS GENUINE OR CLONE,” filed on Nov. 26, 2024 (Attorney Docket No. 3867.C88PRV), which is hereby incorporated by reference herein in its entirety.

### FIELD OF THE DISCLOSURE

This document pertains generally, but not by way of limitation, to classification of integrated circuits, and more particularly, to circuitry and techniques for classifying whether an integrated circuit is anomalous (e.g., genuine versus being a clone or counterfeit device) using analysis of a time series representation of an electrical waveform.

### BACKGROUND

Counterfeit and clone integrated circuit devices present challenges in the semiconductor industry and can affect original equipment manufacturers (OEMs) and end users who rely on the predictable and documented performance of authentic components. In one approach, cryptographically-based authenticator integrated circuit devices, without more, are not always able to prevent clone devices from appearing in the marketplace in substitution for authentic devices. For example, many integrated circuit devices have no cryptographic authentication capabilities, and accordingly, counterfeit or unauthorized clone devices can create market share losses for OEMs when such counterfeit or unauthorized components are substituted for genuine parts. Substitute devices are not restricted to clone or counterfeit devices, and might include recycled or derated devices, placing the performance of other circuits or systems at risk if such substitute devices are unable to meet performance standards associated with genuine or new devices.

### SUMMARY OF THE DISCLOSURE

The present inventors have recognized, among other things, that generally available authentication approaches face limitations in addressing the full scope of the clone device problem. Cryptographic techniques, absent the teachings of the present application, can be effective in some scenarios. However, such approaches can be circumvented by sophisticated cloning operations. Moreover, legacy devices deployed in the field often lack any authentication features, leaving them vulnerable to replacement with non-genuine (e.g., recycled or counterfeit) parts. The present inventors have also recognized, among other things, that authentication techniques can be used that can identify clone or counterfeit integrated circuit devices based on intrinsic characteristics that are difficult for counterfeiters to predict or reproduce. The present subject matter can address challenges in identifying clone or counterfeit devices using anomaly detection techniques applied to time series representations of electric signals associated with integrated circuit devices. For example, by analyzing time series electrical waveforms that capture intrinsic device (e.g., semiconductor or circuit) behavior, such techniques can be used to distinguish genuine devices from clones without requiring traditional cryptographic authentication features or associated infrastructure. In addition to, or instead of device authentication, the present subject matter can also be used for anomaly detection in other contexts, such as to detect an indication of anomalous device aging status, or an indication of an anomalous device electrical stress condition.

In an example, a machine-implemented method can perform anomaly detection, such as for authentication of an integrated circuit device. The method can include capturing an analog electrical waveform from an integrated circuit device during an operational event, applying a time series representation of the captured analog electrical waveform to a machine learning model to generate an output time series representation, wherein the machine learning model was trained using time series representations of analog electrical waveforms representative of reference integrated circuit devices, determining a loss between the time series representation of the captured analog electrical waveform and the output time series representation, and determining whether the integrated circuit device is anomalous based on the loss. For example, the machine learning model can include an autoencoder neural network, and the loss can include a reconstruction loss. Other machine learning models can be used.

In an example, a system can be used for anomaly detection, such as for authenticating an integrated circuit device, the system comprising a controller circuit including an analog-to-digital converter circuit configured to capture an analog electrical waveform from an integrated circuit device during an operational event, and a processor configured to apply a time series representation of the captured analog electrical waveform to a machine learning model to generate an output time series representation, determine a loss between the time series representation and the output time series representation, and determine whether the integrated circuit device is anomalous based on the loss. The machine learning model can be trained using time series representations of analog electrical waveforms representative of reference integrated circuit devices. For example, the processor can include or can be coupled with a neural network accelerator. In an example, the machine learning model can be quantized for embedded deployment on the processor.

In an example, a machine-implemented method for training an anomaly detection model for integrated circuit devices can include generating time series representations of analog electrical waveforms corresponding to a plurality of reference integrated circuit devices and associated operational events, and training a machine learning model using the time series representations to generate output time series representations including reducing or minimizing a loss between the time series representations and the output time series representations. An unsupervised learning approach can be used, according to various examples herein, but other approaches can also be used.

This summary is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example comprising a system that can be used to capture an analog electrical waveform associated with a target device under test, such as for determination of whether the target device is anomalous in some respect.

FIG. 2 illustrates generally a technique, such as a machine-implemented method, for performing anomaly detection, such as using the system of FIG. 1, or according to other examples herein.

FIG. 3A illustrates generally an illustrative example of circuitry such as can be used to capture an analog electrical waveform associated with a target device, such as for training a machine-learning model for use in performing anomaly detection.

FIG. 3B illustrates generally an illustrative example of circuitry such as can be used to capture an analog electrical waveform associated with a target device, such as for use in performing anomaly detection or for implementing such anomaly detection in a field application.

FIG. 3C illustrates generally yet another illustrative example of circuitry such as can be used to capture an analog electrical waveform associated with a target device, such as a current waveform.

FIG. 4A illustrate generally an illustrative example of an analog electrical waveform (corresponding to a power up of a genuine integrated circuit device) showing various features that can be unique to the genuine device versus clone or counterfeit devices.

FIG. 4B and FIG. 4C illustrate generally respective illustrative examples of analog electrical waveforms (corresponding to a memory write operation using circuitry similar to the example of FIG. 3A), where FIG. 4B represents a stand-in “genuine” device, (DS28E54 available from Analog Devices, Inc.), and FIG. 4C represents a stand-in “counterfeit” device (DS2431 available from Analog Devices, Inc.) that is functionally equivalent to the DS28E54 device of FIG. 4B, but which exhibits a different analog fingerprint.

FIG. 5A shows an illustrative example comprising an autoencoder machine learning model topology that can be used for anomaly detection.

FIG. 5B shows an illustrative example of how the machine learning model topology of FIG. 5A can be used to classify whether a time series representation of an unknown target device analog electrical waveform is anomalous.

FIG. 6A and FIG. 6B show respective histograms of reconstruction loss values for a fully-connected neural network topology used in an autoencoder anomaly detection approach as similarly shown in FIG. 5A, where FIG. 6A corresponds to a memory write operational event and FIG. 6B corresponds to a power-up operational event.

FIG. 7A and FIG. 7B show respective histograms of reconstruction loss values for a convolutional neural network topology used in an autoencoder anomaly detection approach as similarly shown in FIG. 5A, where FIG. 7A corresponds to a memory write operational event and FIG. 7B corresponds to a power-up operational event.

FIG. 8A and FIG. 8B show respective histograms of reconstruction loss values for a dual-channel convolutional neural network topology used in an autoencoder anomaly detection approach as similarly shown in FIG. 5A, where FIG. 8A corresponds to a first population of devices, and FIG. 8B corresponds to a larger second population of devices.

FIG. 9 illustrates a block diagram of an example comprising a machine upon which any one or more of the techniques (e.g., methodologies) discussed herein may be performed.

### DETAILED DESCRIPTION

Anomaly detection can refer to the identification of events, patterns, or observations that deviate from normal within a dataset. The present inventors have recognized that anomaly detection can be performed using analog waveform fingerprints associated with integrated circuit devices. As an illustration, low-cost authenticator devices used for applications such as disposable or recyclable items (e.g., printer cartridges) can exhibit such analog fingerprints associated with operational events such as a power-on reset, power up, or a memory access event such as a memory write. A machine-learning-based approach can be used to determine whether an observed time series representation of an analog waveform represents a normal or anomalous device. For example, this approach can be used to identify likely clone or counterfeit devices, or for other applications such as identifying devices that have been recycled and resold as new or that otherwise deviate from nominal performance for whatever reason (substitution, aging status, or evidence of electrical stress condition such as overstress, as examples). As a proof of concept, parasitically-powered 1-Wire® authenticator devices are evaluated using various techniques, and an autoencoder-based approach can reliably detect integrated circuit devices that deviate from a population of reference devices. The approaches described herein are not restricted to 1-Wire® authenticator devices and are applicable to a variety of other integrated circuit devices where an analog waveform can be monitored and digitized, and evaluated using a machine learning approach as described herein.

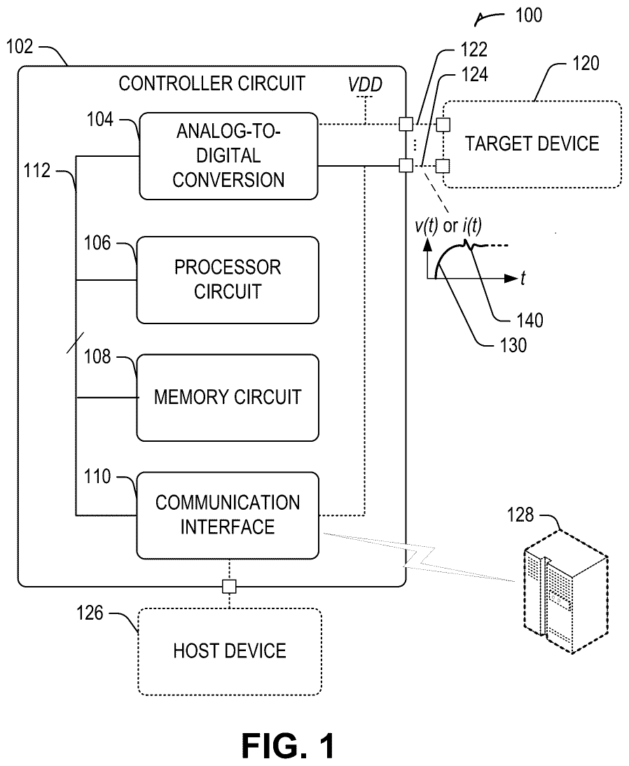

FIG. 1 illustrates generally an example comprising a system 100 that can be used to capture an analog electrical waveform associated with a target device under test, such as for determination of whether the target device is anomalous in some respect. The system 100 can be configured to interface with a target device 120, such as being conductively connected with the target device 120 through one or more nodes such as a supply node 122 or a communication node 124 (or a combined supply and communication node, such as VIO, as shown in other examples in this document). The controller circuit can include one more communication interfaces 110, such as to interface with the target device 120, or to communicate with other elements such as a host device 126 or remote facility 128.

The controller circuit 102 can include an analog-to-digital converter (ADC) circuit 104 configured to capture an analog electrical waveform 130 from the target device 120 during an operational event. The analog electrical waveform 130 can include a voltage waveform (v(t)) or a current waveform (i(t)) as a function of time. As shown and described elsewhere herein, the analog electrical waveform 130 can include one or more features such as a fingerprint 140 that can be used to characterize whether an unknown target device 120 is a member of a reference class of devices. For example, the fingerprint 140 may be present only in authentic devices, as an illustrative example. The ADC circuit 104 can digitize the analog electrical waveform 130, to generate a time series representation of the analog electrical waveform 130. The system 100 can include a processor circuit 106 configured to apply the time series representation of the captured analog electrical waveform 130 to a machine learning model. For example, the processor circuit 106 can instantiate or be coupled with a machine learning model to evaluate the target device 120. For example, the machine learning model can include an encoder to transform the digitized time series representation of the captured analog electrical waveform 130 into a latent space, and an embedded representation of the captured analog electrical waveform 130 can be compared to a reference embedding to determine whether an anomaly exists (such as using a Euclidean distance or other metric). In another approach, an autoencoder topology can be used, such as to generate an output time series representation for comparison with the digitized time series representation of the captured analog electrical waveform 130. A loss metric (e.g., a mean squared error or other reconstruction loss) can be evaluated between the time series representation of the captured analog electrical waveform 130 as an input and the output of the autoencoder.

In an example, the processor circuit 106 can be communicatively coupled with or can comprise a neural network accelerator or other processing circuitry configured to instantiate the machine learning model. The system 100 can include a memory circuit 108, such as comprising instructions that when executed by the processor circuit, cause the processor circuit 106 to perform a machine-implemented method as shown and described herein. Elements of the controller circuit 102 can communicate with each other using one or more communication buses such as a bus 112.

In another example, a host device 126 or remote facility 128 can trigger an anomaly determination, such as triggering acquisition of the time series representation of the captured analog electrical waveform 130 or the host device 126 or remote facility 128 can otherwise control or perform portions of a machine-implemented method as shown and described herein. The host device 126 or remote facility 128 can receive a result of a determination made by the controller circuit 102 as to whether the target device 120 is anomalous. An indication of an anomaly in the target device 120 can include an anomaly with respect to device authenticity (e.g., where the target device 120 fails an authenticity determination), or with respect to other factors such as device aging or device overstress.

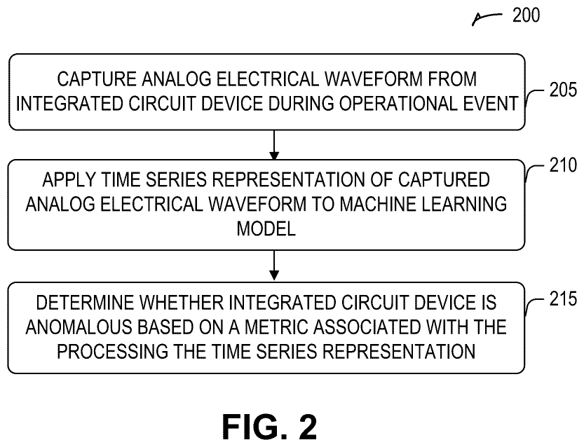

FIG. 2 illustrates generally a technique, such as a machine-implemented method 200, for performing anomaly detection, such as using the system 100 of FIG. 1, or according to other examples herein. In FIG. 2, at 205, an analog electrical waveform can be captured (e.g., digitized and converted to a digital time series representation using an analog-to-digital converter circuit). At 210, the time series can be applied to a machine learning model as an input, such as to generate an embedding representative of the input to the machine learning model in a latent space (e.g., using an encoder topology), or to reconstruct a time series representation corresponding to the input time series representation as an output (e.g., using an autoencoder topology). At 215, a determination can be made whether the analog electrical waveform “fingerprint” associated with a target device under test is anomalous based on applying a metric to the output generated at 210 from the machine learning model.

Evaluation of the feasibility and performance of the approaches described herein was performed using low-cost 1-Wire® authenticator integrated circuit devices. Such devices produce a variety of different analog fingerprints, such as those associated with power-up or memory write operational events. Time series representations of such events can be on the order of a few hundred thousand samples and can be subsampled to facilitate reductions in redundancy or to enhance processing efficiency, as illustrative examples.

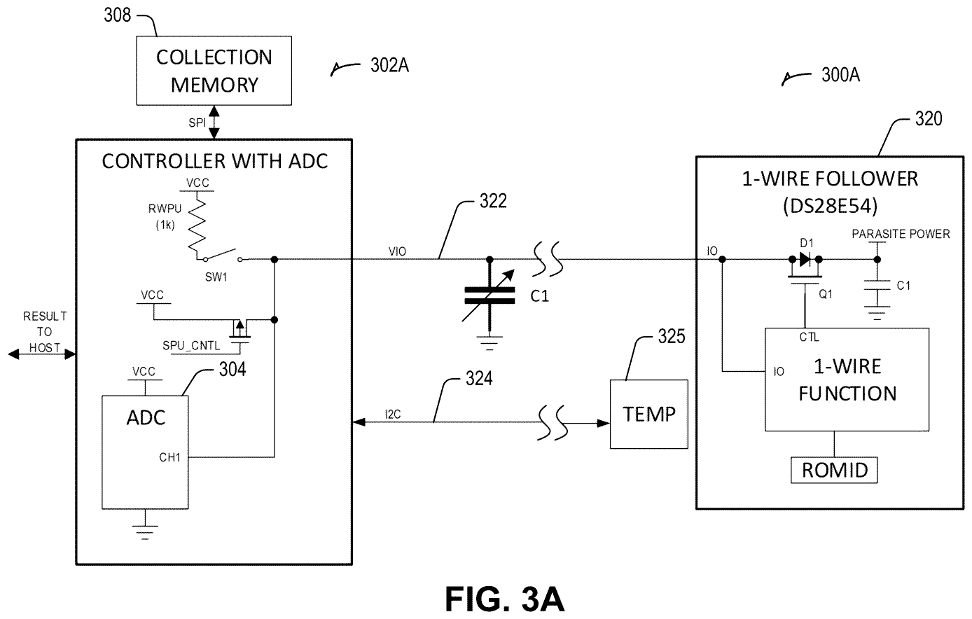

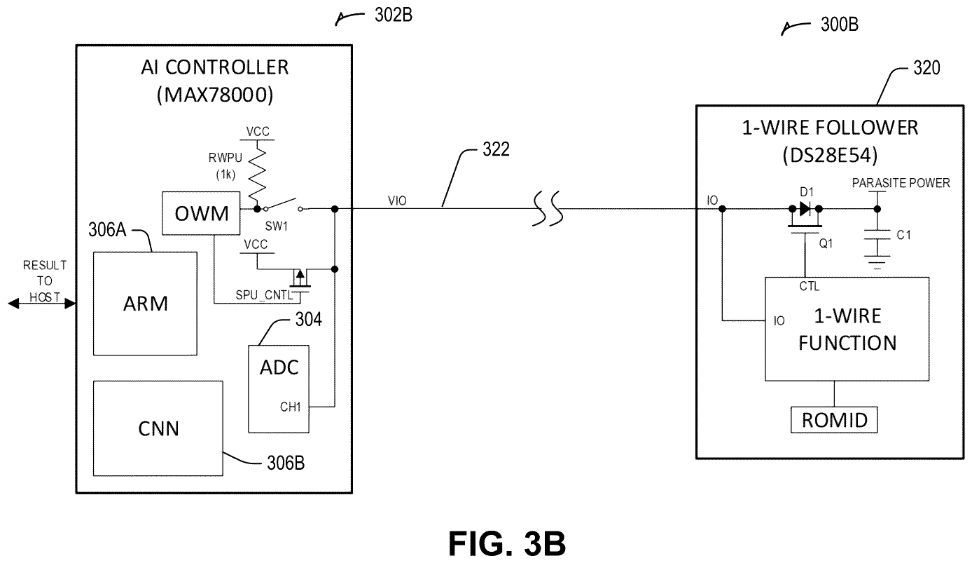

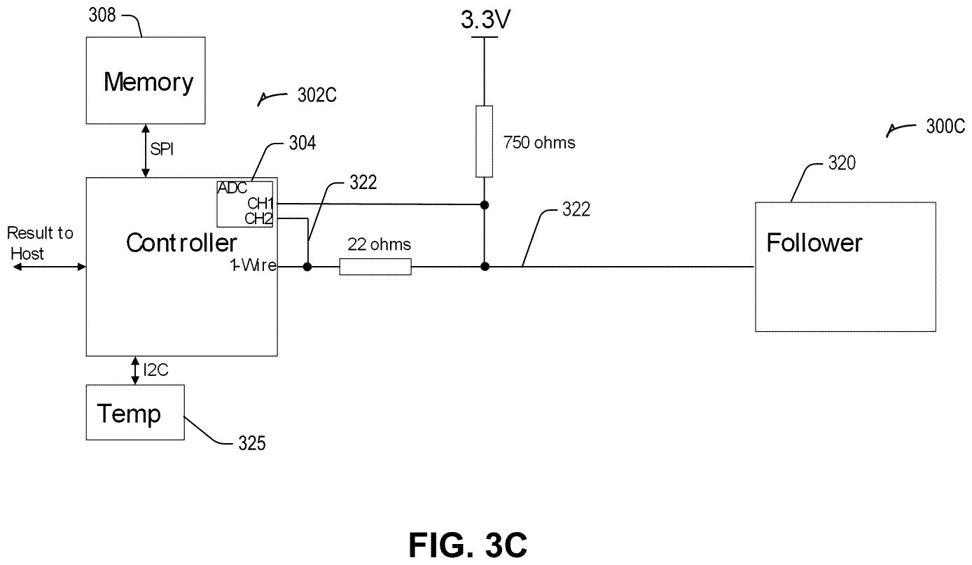

FIG. 3A illustrates generally an illustrative example of circuitry 300A such as can be used to capture an analog electrical waveform associated with a follower device 320, such as for training a machine-learning model for use in performing anomaly detection. Use of a controller/follower topology is merely illustrative and other target devices need not be follower devices in all applications of the present subject matter.

In the example of FIG. 3A, a controller circuit 302A can include or can be communicatively coupled with a collection memory 308 to store acquired time series data. The controller circuit 302A can include an analog-to-digital converter circuit 304, such as configured to monitor a VIO node 322 (e.g., a combined power and communication node). Generally, 1-Wire® follower devices 320 (such as the DS28E54 device of FIG. 3A) are parasitically powered using the VIO node 322 and a small capacitor C1 internal to the follower device 320. The controller circuit 302A can trigger acquisition of an analog waveform on the VIO node 322 by the ADC circuit 304, such as in association with one or more different operational events. A variety of different follower devices 320 can be evaluated, such as also monitoring other parameters such as temperature using a temperature sensor 325 and associated communication bus 324. For example, a training dataset can include capturing time series data across different VIO node 322 capacitance values (shown in FIG. 3A as larger C1 on the VIO node 322 that is variable), and at different temperatures. Other variations in the training data set can include using follower devices 320 from different design or die revisions, package styles, fabrication facilities, or lots, as illustrative examples. In general, the training approach seeks to reduce or minimize a loss between an input time series waveform representing a “genuine” device, and a reconstructed waveform at the output of the machine learning model (where an autoencoder topology is used). As an illustration, the training data set could include a population of devices that vary across process, voltage, and temperature.

FIG. 3B illustrates generally an illustrative example of circuitry 300B such as can be used to capture an analog electrical waveform associated with a follower device 320, such as for use in performing anomaly detection or for implementing such anomaly detection in a field application. As an illustrative example, a controller circuit 302B (e.g., a MAX78000 device for this illustrative example) can include an ARM-based general purpose processor circuit 306A and, optionally, a separate a neural network accelerator or other special purpose processor circuitry, such as to instantiate a convolutional neural network CNN processor circuit 306B. In an embedded deployment or for greater computational efficiency, a quantized representation of the neural network can be used, such as using lesser bit resolution for weightings or activations. A follower device 320 being evaluated as a target device can be monitored during an operational event such as power up or a memory write, where an analog-to-digital converter circuit 304 can acquire a time series representation of an analog waveform on the VIO node 322. A determination as to whether the target device (e.g., a follower device 320 under test) is anomalous (e.g., genuine versus a counterfeit or clone) can be made by the controller circuit 302B, and a result of the anomaly detection can be communicated to a host. In general, such anomaly determination for purposes of authentication can be performed either alone (for legacy devices lacking cryptographic authentication), or in combination with cryptographic authentication to provide an added layer of authentication or anomaly detection.

The approaches described herein are not restricted to monitoring of voltage waveforms. For example, if a current sensor is available or a current sensing resistor is used, a current waveform can be monitored either in addition to a voltage waveform (e.g., using a multi-channel machine learning model or multiple models) or instead of a voltage waveform. For example, FIG. 3C illustrates generally yet another illustrative example of circuitry 300C such as can be used to capture an analog electrical waveform associated with a target device (e.g., follower device 320), such as a current waveform. A controller circuit 302C can include or can be communicatively coupled with a memory 308. An analog-to-digital converter circuit 304 can include multiple channels, such as input channel (CH1) coupled to a power or communication node, or a combined power and communication node 322 (e.g., VIO). A current sense resistor can be used, and a second analog-to-digital converter circuit 304 channel (CH2) can provide a voltage measurement, where a voltage drop between CH1 and CH2 can indicate a current. Temperature monitoring can be performed as in other examples, such as using a temperature sensor 325 to provide temperature-dependent or temperature-compensated anomaly detection.

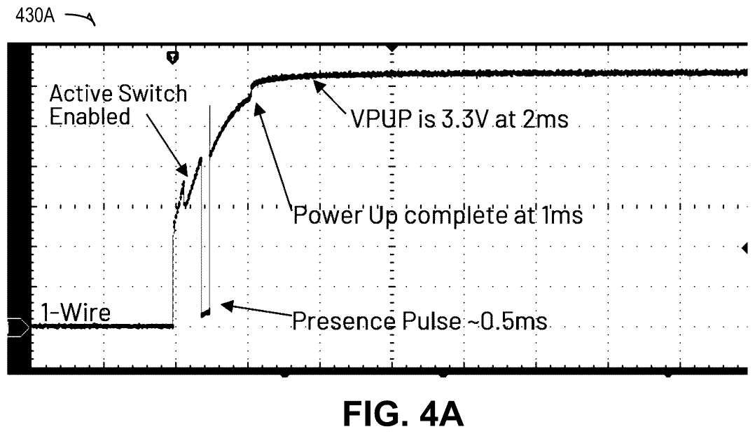

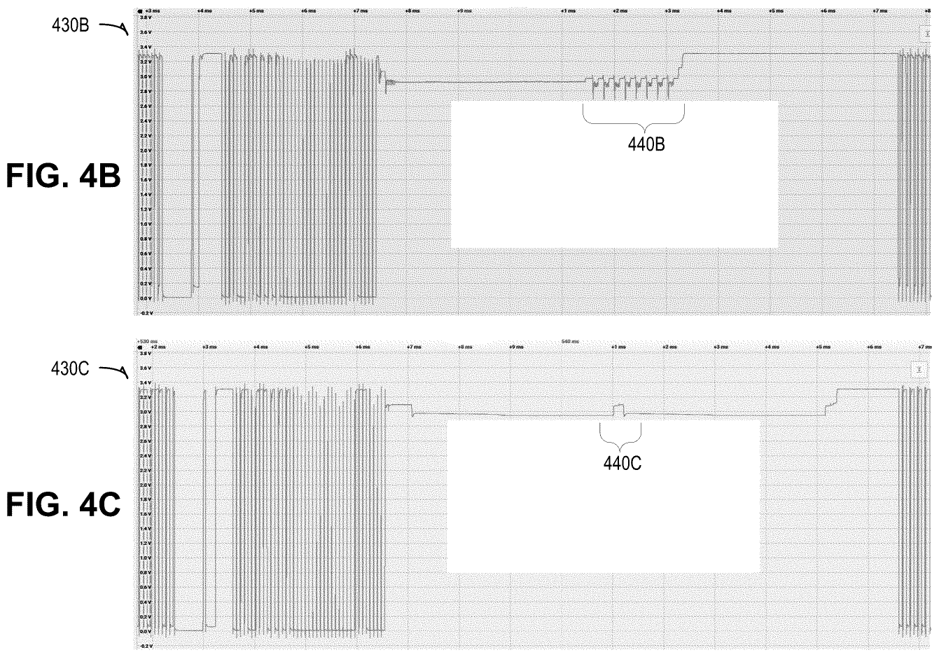

FIG. 4A illustrate generally an illustrative example of an analog electrical waveform 430A (corresponding to a power up of a genuine integrated circuit device) showing various features that can be unique to the genuine device versus clone or counterfeit devices. The analog electrical waveform 430A was captured from a parasitically-powered 1-Wire® authenticator integrated circuit device where power is derived from the VIO signal pin. As shown in FIG. 4A, a power-on-reset can be forced for a 1-Wire® device by a controller cycling the VIO pin long enough, and upon completing power up within 2 milliseconds, an authentic 1-Wire® device issues a power up presence detect pulse. By contrast, a microcontroller clone device has a much longer power-up duration, generally taking many milliseconds before being ready to process commands, and microcontroller-based clones typically do not have capability to generate the presence detect pulse so quickly. Also, more current is usually required for clones to work, so their associated parasite power capacitor is larger than a genuine device. These aspects can cause the power up waveform of a counterfeit or clone device to appear different than the analog electrical waveform 430A shown in FIG. 4A. A machine learning model can be trained using waveforms similar to the waveform 430A of FIG. 4A, so that such anomalous waveforms of clone or counterfeit devices can be detected as shown and described in other examples herein.

FIG. 4B and FIG. 4C illustrate generally respective further illustrative examples of analog electrical waveforms (corresponding to a memory write operation using circuitry similar to the example of FIG. 3A), where FIG. 4B represents a stand-in “genuine” device, (DS28E54 available from Analog Devices, Inc.), and FIG. 4C represents a stand-in “counterfeit” device (DS2431 available from Analog Devices, Inc.) that is functionally equivalent to the DS28E54 device of FIG. 4B, but which exhibits a different analog fingerprint. An analog electrical waveform (e.g., voltage waveform 430B) captured from the VIO node shows unique pulses in a fingerprint region 440B during the write operation, where the pulses in the fingerprint region 440B have no functional impact on VIO bus communication, but are visible on the voltage waveform 430B. By contrast, a voltage waveform 430C shows a different pulse shape in the fingerprint region 440C as compared to a similar region 440B in FIG. 4B. Even though the devices under test in FIG. 4B and FIG. 4C are functionally equivalent, their electrical behavior during a memory write operation is visibly different, and a machine learning approach can be used to detect such differences through various metrics, depending on the model architecture.

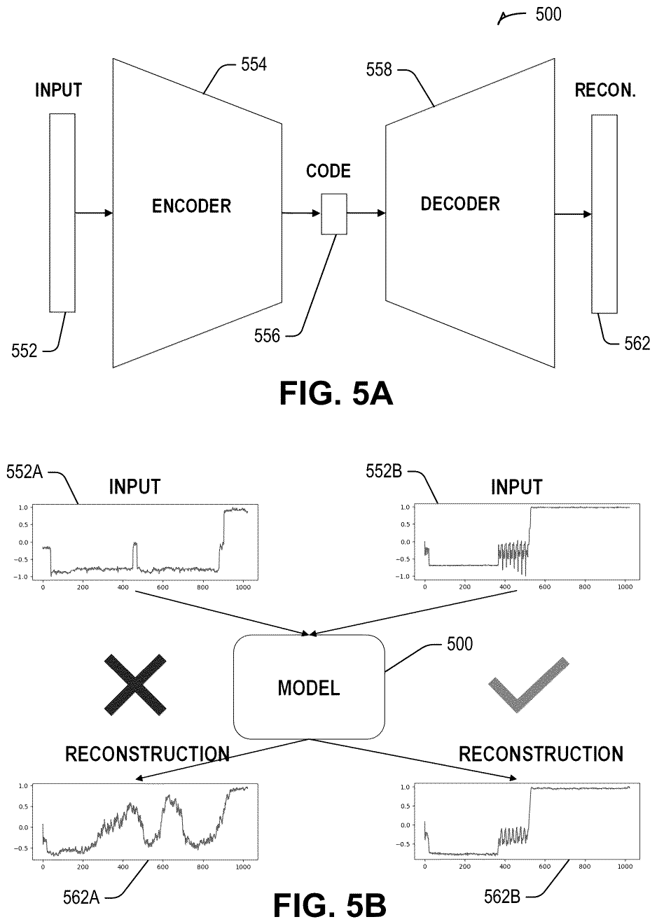

For example, FIG. 5A shows an illustrative example comprising an autoencoder machine learning model 500 topology that can be used for anomaly detection. Time-series numerical data can be captured and used as an input 552 to an encoder 554 neural network, to provide an embedding or code 556 (e.g., a compressed) representation of the input in a latent vector space. The code 556 representation is then provided as an input to a decoder 558 neural network, to provide a reconstructed output 562. Generally, the encoder and decoder are trained using an unsupervised learning approach. An unsupervised learning approach is suitable for applications involving anomaly detection involving genuine versus clone or counterfeit devices, because the model can be trained without requiring access to all possible clone or counterfeit devices, while access to genuine devices is assumed.

Generally, both the encoder 554 portion and decoder 558 portion of the autoencoder have multiple layers, and respective layers can fractionally reduce (or in the case of the decoder, reconstruct) their inputs before passing them to the next layer. Linear and convolutional approaches were evaluated, and use of an autoencoder topology is merely one example.

FIG. 5B shows an illustrative example of how the autoencoder machine learning model 500 topology of FIG. 5A can be used to classify whether a time series representation of an unknown target device analog electrical waveform is anomalous. Anomaly detection is an approach that can refer to identification of data as somehow uncommon reference to previous data that was represents a normal or reference state. In an autoencoder approach, an input 552A representative of an anomalous analog waveform (such as from a cloned or counterfeit device) will result in an output reconstruction 562A that significantly differs from the input 552A. Such a difference can be detected analytically by determining a mean squared error or other metric between the input 552A and the output reconstruction 562A. If the loss exceeds a specified threshold, the input 552A can be deemed indicative of an anomalous condition or device. By contrast, when an input 552B representative of a nominal or typical analog waveform is provided, the model 500 can generate a reconstruction 562B that more closely matches the input 552B, which will result in a correspondingly lower loss. This assumes that the model 500 was trained using data corresponding to reference devices that have analog waveforms more similar to 552B than 552A. In an unsupervised approach, such nominal waveforms need not be labeled as such.

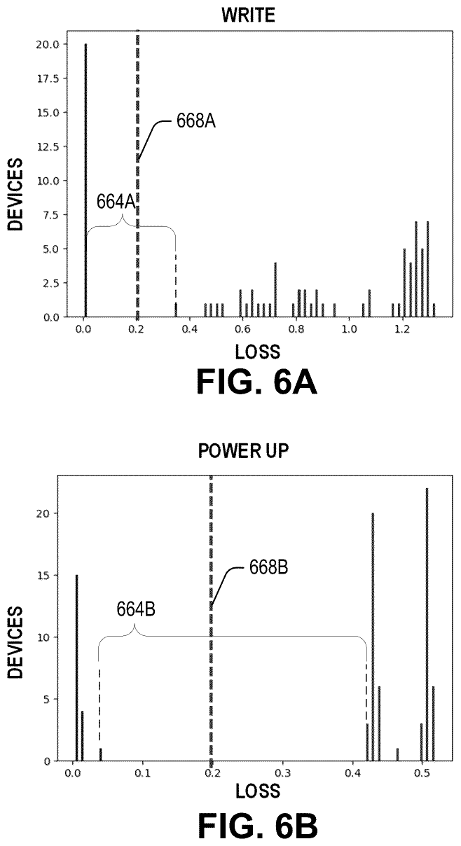

FIG. 6A and FIG. 6B show respective histograms of reconstruction loss values for a fully-connected neural network topology used in an autoencoder anomaly detection approach as similarly shown in FIG. 5A, where FIG. 6A corresponds to a memory write operational event and FIG. 6B corresponds to a power-up operational event. The population of devices deemed “genuine” are shown to the left of respective reconstruction loss threshold values, including threshold value 668A in FIG. 6A and threshold value 668B in FIG. 6B, and devices deemed anomalous are shown to the right.

A separation 664A in FIG. 6A, and a separation 664B in FIG. 6B is shown between the lowest-loss anomalous devices and the highest loss genuine devices. Such a separation can serve as a figure of merit for comparison between different classification approaches, and a normalized separation metric can be computed that quantifies the degree of separation in a way that facilitates comparison across different models and datasets. As an illustration, the normalized separation metric can be calculated as a difference between a maximum loss for a genuine device and a minimum loss for a non-genuine device, scaled by a normalization operation. For example, the normalization can include dividing the determined difference by a maximum loss for a non-genuine device, or by a range defined as the minimum loss for a genuine device and the maximum loss for a non-genuine device, or by a central tendency (e.g., mean or median of a population of losses), or by an indication of dispersion (e.g., variance, standard deviation), as illustrative examples.

The autoencoder machine learning model used for generation of the results of FIG. 6A and FIG. 6B used a linear function for each layer to specify features to be output by respective layers based on the features input to the respective layers. The time series data was input as one-dimensional numerical data. In the encoder, a count of output features of each layer was smaller than a count of features entering the layer, and the decoder had a count of output features at each layer that was greater than a count of input features for the layer. For the illustrative examples in FIG. 6A and FIG. 6B, and others below, the autoencoder machine learning models were implemented using a neural network module that is part of the PyTorch API.

The device population evaluated to generate the histograms of FIG. 6A and FIG. 6B comprised 94 samples of DS28E54 devices assigned as “genuine” for training, with a test data set including a separate set of 20 “genuine” DS28E54 devices, along with 31 DS28E07 devices and 30 DS2431 devices standing in as “anomalous” devices. Using a threshold reconstruction loss of 0.2 for both the write and power-up models, confusion matrices were computed corresponding to the write and power up operational events of FIG. 6A and FIG. 6B.

TABLE 1
Confusion Matrix for Power-Up

| | | |
|---|---|---|
| 0 | N: 61 | FP: 0 |
| 1 | FN: 0 | P: 20 |
| | 0 | 1 |

TABLE 2
Confusion Matrix for Memory Write

| | | |
|---|---|---|
| 0 | N: 61 | FP: 0 |
| 1 | FN: 0 | P: 20 |
| | 0 | 1 |

In both cases (memory write and power up), there were 61 “negative” results corresponding to the “anomalous” devices, and 20 “positive” results corresponding to the “genuine” devices (where reconstruction loss was below the threshold value 668A for memory write and 668B for power up). For the memory write operational event of FIG. 6A, the confusion matrix indicated 61 true negatives (anomalous devices correctly classified), 0 false positives (anomalous devices incorrectly classified as genuine), 0 false negatives (genuine devices incorrectly classified as anomalous), and 20 true positives (genuine devices correctly classified). Similarly, for the power-up operational event of FIG. 6B, the confusion matrix indicated 61 true negatives, 0 false positives, 0 false negatives, and 20 true positives. The threshold value of 0.2 is lenient to the models, allowing for larger separation between the genuine devices without any clone actors being detected as genuine. The normalized separation metric for the memory write operational event was calculated as 0.3455, and for the power-up operational event was calculated as 0.8226.

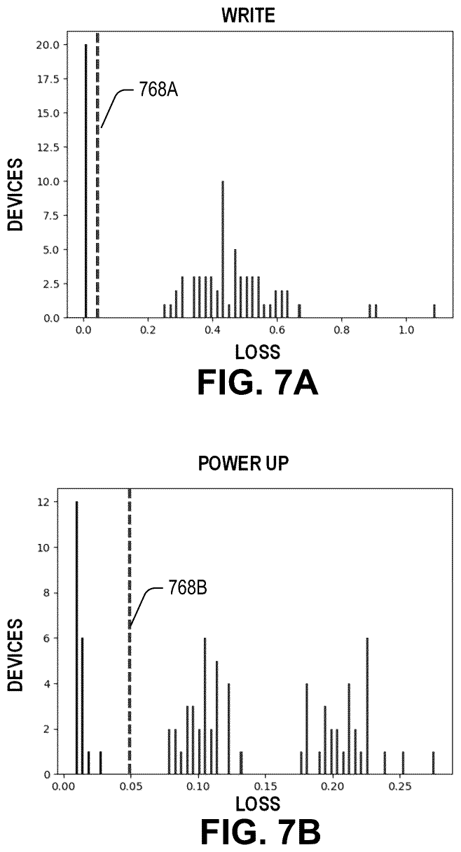

FIG. 7A and FIG. 7B show respective histograms of reconstruction loss values for a convolutional neural network topology used in an autoencoder anomaly detection approach as similarly shown in FIG. 5A, where FIG. 7A corresponds to a memory write operational event and FIG. 7B corresponds to a power-up operational event. The population of devices deemed “genuine” are shown to the left of respective reconstruction loss threshold values, including a threshold value 768A in FIG. 7A, and a threshold value 768B in FIG. 7B, and devices deemed anomalous are shown to the right. For this example, a convolutional approach was generally not as effective as the fully-connected approach, showing less consistent performance across different testing iterations.

TABLE 3
Confusion Matrix for Power-Up

| | | |
|---|---|---|
| 0 | N: 61 | FP: 0 |
| 1 | FN: 0 | P: 20 |
| | 0 | 1 |

TABLE 4
Confusion Matrix for Memory Write

| | | |
|---|---|---|
| 0 | N: 61 | FP: 0 |
| 1 | FN: 0 | P: 20 |
| | 0 | 1 |

The results for these models used a different (and lower) threshold of 0.05 in loss, which demonstrates how the model is able to reconstruct output waveforms with low loss even when provided with input from “clone” devices, as compared to the fully-connected approach. Using the threshold reconstruction loss of 0.05 for both models, confusion matrices were computed corresponding to the write and power up operational events of FIG. 7A and FIG. 7B. Nevertheless, for the memory write operational event of FIG. 7A, the confusion matrix indicated 61 true negatives, 0 false positives, 0 false negatives, and 20 true positives. For the power-up operational event of FIG. 7B, the confusion matrix indicated 61 true negatives, 0 false positives, 0 false negatives, and 20 true positives. The normalized separation metric for the memory write operational event was calculated as 0.5023, and for the power-up operational event was calculated as 0.3509. The normalized separation shows a similar outcome as compared to the fully-connected neural network topology, with a higher value from the memory write fingerprint.

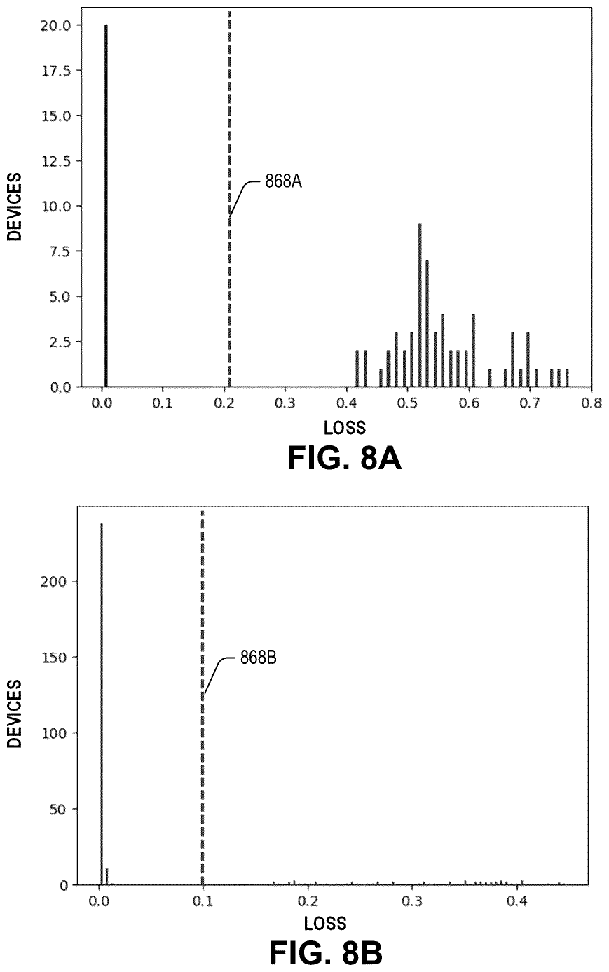

FIG. 8A and FIG. 8B show respective histograms of reconstruction loss values for a dual-channel convolutional neural network topology used in an autoencoder anomaly detection approach as similarly shown in FIG. 5A, where FIG. 8A corresponds to a first population of devices, and FIG. 8B corresponds to a larger second population of devices. The dual-channel architecture represents a departure from the single-channel approaches shown in FIG. 6A, FIG. 6B, FIG. 7A, and FIG. 7B. Rather than training and testing two separate autoencoder models (one for power-up operational events and one for memory write operational events), the dual-channel model takes both fingerprints as input channels to a single convolutional autoencoder. This approach processes both the power-up time series and the memory write time series contemporaneously through the same encoder-decoder architecture, where the two channels are presented as parallel inputs to the convolutional layers. The aggregated fingerprinting approach allows the model to learn correlations between the two operational signatures, potentially making the signatures associated with the reference device population unique or more distinguishable, because clones would need to replicate fingerprints used for both of the input channels accurately to avoid detection. Use of two channels is merely illustrative, and a multi-channel approach can be used having more than two input channels.

For the first population shown in the illustration of FIG. 8A, the device population was the same as used for FIG. 6A, FIG. 6B, FIG. 7A, and FIG. 7B: 94 DS28E54 devices were used for training as “genuine,” with testing performed on a separate set of 20 DS28E54 devices, along with 31 DS28E07 devices and 30 DS2431 devices (serving as “clone” actors). The population of genuine devices are shown to the left of reconstruction loss threshold value 868A, and clone actors are shown to the right. Using a threshold reconstruction loss of 0.2, the confusion matrix for FIG. 8A indicated 61 true negatives (“clone” actors correctly classified as anomalous), 0 false positives (“clone” actors incorrectly classified as “genuine”), 0 false negatives (“genuine” devices incorrectly classified as “anomalous”), and 20 true positives (“genuine” devices correctly classified as “genuine”). The normalized separation metric for this population was calculated as 0.7200, indicating improved separation compared to single-channel models.

TABLE 5
Confusion Matrix for Dual Channel Model

| | | |
|---|---|---|
| 0 | N: 61 | FP: 0 |
| 1 | FN: 0 | P: 20 |
| | 0 | 1 |

For the larger second population shown in FIG. 8B, the dual-channel model was tested with an expanded database comprising approximately 1000 DS28E54 devices plus 61 clone actors (DS28E07 and DS2431 devices). Of these, 750 devices were used in training (“genuine” devices only, with no clones included in training), and 311 devices were used in testing (including both “genuine” and “clone” devices). The population of “genuine” devices are shown to the left of reconstruction loss threshold value 868B, and clone actors are shown to the right. Using a threshold reconstruction loss of 0.1, the confusion matrix for FIG. 8B indicated 61 true negatives, 0 false positives, 0 false negatives, and 250 true positives. The normalized separation metric for this larger population was calculated as 0.5122.

TABLE 6
Confusion Matrix for Dual Channel Model with Larger Population

| | | |
|---|---|---|
| 0 | N: 61 | FP: 0 |
| 1 | FN: 0 | P: 250 |
| | 0 | 1 |

The loss histogram of FIG. 8B shows that the model behaves similarly to the convolutional model examples of FIG. 7A and FIG. 7B. The “genuine” devices test very closely in terms of loss values, clustering tightly at low reconstruction loss near zero. The “clone” actors show broader distribution at higher loss values extending beyond 0.2. The decrease in normalized separation compared to FIG. 8A is due to increased separation in the reconstruction loss results of the clone actors (extending to higher loss values) rather than degradation in genuine device classification, as evidenced by the continued tight clustering of genuine devices at relatively low loss values. A threshold of 0.1 or greater remains sufficiently lenient to prevent genuine devices from being incorrectly detected as clones while maintaining effective separation between genuine and clone devices.

In general, a suitable population of training devices can be used such as representing particular lots, a plurality of lots, a single die revision, a plurality of die revisions, a single package style, a plurality of package styles, a single temperature, or a variety of temperatures, a single supply voltage, a variety of supply voltages, or other variations. For example, the training dataset could represent devices that do not show deleterious aging effects, with anomalous devices representing devices representing an anomaly with respect to device aging.

The use of an autoencoder neural network topology is also merely one example. Other machine learning models can be used, as discussed elsewhere herein, without requiring an autoencoder topology. For example, a one-class neural network approach can be used, which can be trained using an unsupervised learning approach. In the latent space associated with a one-class network, conforming “genuine” devices can be inside a hypersphere associated with the latent space, and anomalous devices can be outside the hypersphere.

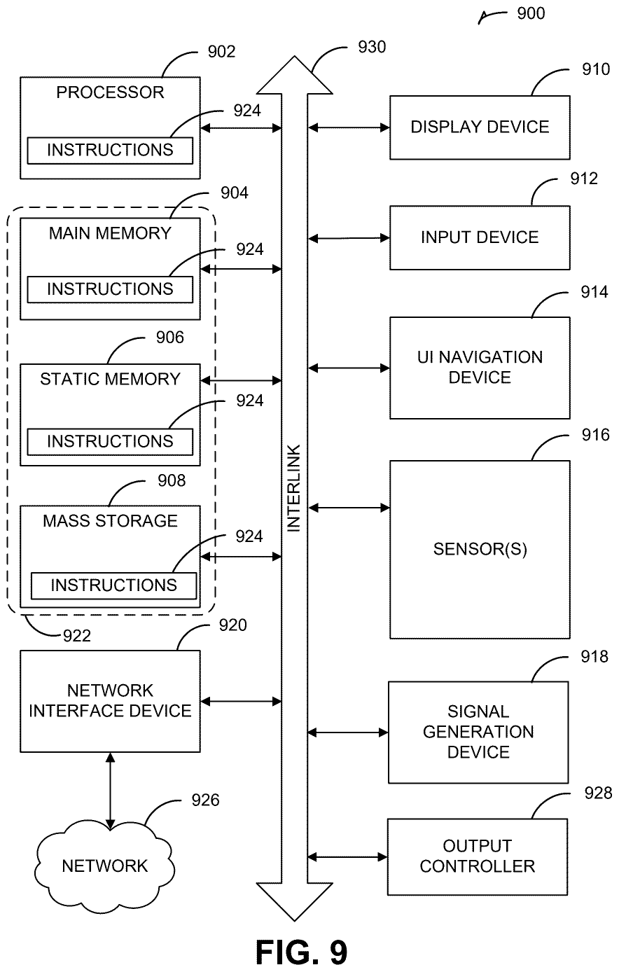

FIG. 9 illustrates a block diagram of an example comprising a machine 900 upon which any one or more of the techniques (e.g., methodologies) discussed herein may be performed. Machine 900 (e.g., computer system) may include a hardware processor 902 (e.g., a central processing unit (CPU), a graphics processing unit (GPU), a hardware processor core, or any combination thereof), a main memory 904 and a static memory 906, connected via an interlink 930 (e.g., link or bus), as some or all of these components may constitute hardware for systems or related implementations discussed above.

Generally, the hardware processor 902 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor circuit may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor circuit may be emulated in software, running on a physical processor, as a virtual processor or virtual circuit. The virtual processor may behave like an independent processor but is implemented in software rather than hardware.

Specific examples of main memory 904 include Random Access Memory (RAM), and semiconductor memory devices, which may include storage locations in semiconductors such as registers. Specific examples of static memory 906 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine 900 may further include a display device 910, an input device 912 (e.g., a keyboard), and a user interface (UI) navigation device 914 (e.g., a mouse). In an example, the display device 910, input device 912, and UI navigation device 914 may be a touch-screen display. The machine 900 may include a mass storage device 908 (e.g., drive unit), a signal generation device 918 (e.g., a speaker), a network interface device 920, and one or more sensors 916, such as a global positioning system (GPS) sensor, compass, accelerometer, or some other sensor. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 908 may comprise a machine-readable medium 922 on which is stored one or more sets of data structures or instructions 924 (e.g., software) embodying or utilized by any one or more of the techniques or functions described herein. The instructions 924 may also reside, completely or at least partially, within the main memory 904, within static memory 906, or within the hardware processor 902 during execution thereof by the machine 900. In an example, one or any combination of the hardware processor 902, the main memory 904, the static memory 906, or the mass storage device 908 comprises a machine readable medium.

Specific examples of machine-readable media include, one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions 924.

An apparatus of the machine 900 includes one or more of a hardware processor 902 (e.g., a central processing unit (CPU), a graphics processing unit (GPU), a hardware processor core, or any combination thereof), a main memory 904 and a static memory 906, sensors 916, network interface device 920, antennas, a display device 910, an input device 912, a UI navigation device 914, a mass storage device 908, instructions 924, a signal generation device 918, or an output controller 928. The apparatus may be configured to perform one or more of the methods or operations disclosed herein.

The term “machine readable medium” includes, for example, any medium that is capable of storing, encoding, or carrying instructions for execution by the machine 900 and that cause the machine 900 to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions 924 may be transmitted or received, for example, over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, a Long Term Evolution (LTE) 4G or 5G family of standards, a Universal Mobile Telecommunications System (UMTS) family of standards, peer-to-peer (P2P) networks, satellite communication networks, among others.

In an example, the network interface device 920 includes one or more physical jacks (e.g., Ethernet, coaxial, or other interconnection) or one or more antennas to access the communications network 926. In an example, the network interface device 920 includes one or more antennas to wirelessly communicate using at least one of single-input multiple-output (SIMO), multiple-input multiple-output (MIMO), or multiple-input single-output (MISO) techniques. In some examples, the network interface device 920 wirelessly communicates using Multiple User MIMO techniques. The term “transmission medium” shall be taken to include any intangible medium that is capable of storing, encoding or carrying instructions for execution by the machine 900, and includes digital or analog communications signals or other intangible medium to facilitate communication of such software.

### Various Notes

Each of the non-limiting examples herein can stand on its own or can be combined in various permutations or combinations with one or more of the other aspects or other subject matter described in this document.

Example 1 can include or use subject matter (such as an apparatus, a method, a means for performing acts, or a device readable medium including instructions that, when performed by the device, can cause the device to perform acts), such as can include or use a machine-implemented method for authenticating integrated circuit devices, the method including capturing an analog electrical waveform from an integrated circuit device during an operational event, apply a time series representation of the captured analog electrical waveform to a machine learning model to generate an output time series representation, determining a loss between the time series representation of the captured analog electrical waveform and the output time series representation, and determining whether the integrated circuit device is anomalous based on the loss, where the machine learning model was trained using time series representations of analog electrical waveforms representative of reference integrated circuit devices.

Example 2 can include, or can optionally be combined with the subject matter of Example 1, to optionally include that the machine learning model includes an autoencoder neural network, and where the loss includes a reconstruction loss.

Example 3 can include, or can optionally be combined with the subject matter of Example 2, to optionally include that the autoencoder neural network includes an encoder portion configured to compress the time series representation into a latent representation and a decoder portion configured to reconstruct the time series representation from the latent representation as the output time series representation.

Example 4 can include, or can optionally be combined with the subject matter of Example 3, to optionally include that the encoder portion or the decoder portion includes fully-connected layers.

Example 5 can include, or can optionally be combined with the subject matter of Example 3, to optionally include that the encoder portion or the decoder portion includes a convolutional topology.

Example 6 can include, or can optionally be combined with the subject matter of Example 2, to optionally include that the reconstruction loss includes a mean squared error between the time series representation of the captured analog electrical waveform and the output time series representation.

Example 7 can include, or can optionally be combined with the subject matter of Example 2, to optionally include that determining whether the integrated circuit device is anomalous based on the loss includes comparing the reconstruction loss to a threshold.

Example 8 can include, or can optionally be combined with the subject matter of Example 7, to optionally include that the integrated circuit device is determined to be anomalous when the reconstruction loss is at or above a specified threshold.

Example 9 can include, or can optionally be combined with the subject matter of Example 1, to optionally include that the operational event includes a power-up event, a power-on-reset event, or a memory write event.

Example 10 can include, or can optionally be combined with the subject matter of Example 1, to optionally include that the analog electrical waveform includes a voltage waveform or a current waveform.

Example 11 can include, or can optionally be combined with the subject matter of Example 1, to optionally include that the integrated circuit device includes a communication node, a power node, or a combined communication and power node, and where capturing the analog electrical waveform includes digitizing a signal associated with the communication node, the power node, or the combined communication and power node, using an analog-to-digital converter circuit.

Example 12 can include, or can optionally be combined with the subject matter of Example 1, to optionally include capturing a second analog electrical waveform from the integrated circuit during another operational event different from a first operational event, and processing a second time series representation of the second analog electrical waveform using another channel of the machine learning model, the machine learning model including a dual-channel or multi-channel architecture.

Example 13 can include, or can optionally be combined with the subject matter of Example 1, to optionally include that the reference integrated circuit devices represent genuine devices, and where the loss indicative that the integrated circuit device is anomalous is with respect to device authenticity.

Example 14 can include, or can optionally be combined with the subject matter of Example 1, to optionally include that the reference integrated circuit devices represent nominal or new devices, and where the loss indicative that the integrated circuit device is anomalous is with respect to device aging status or device electrical stress condition.

Example 15 can include, or can optionally be combined with the subject matter of one or any combination of Examples 1 through 14 to include, subject matter (such as an apparatus, a system, a means for performing acts, or a machine-readable medium including instructions that, when performed by the machine, can cause the machine to perform acts), such as can include a system for authenticating integrated circuit devices including a controller circuit including an analog-to-digital converter circuit configured to capture an analog electrical waveform from an integrated circuit device during an operational event, a processor configured to apply a time series representation of the captured analog electrical waveform to a machine learning model to generate an output time series representation, determine a loss between the time series representation and the output time series representation, and determine whether the integrated circuit device is anomalous based on the loss, where the machine learning model was trained using time series representations of analog electrical waveforms representative of reference integrated circuit devices.

Example 16 can include, or can optionally be combined with the subject matter of Example 15, to optionally include that the processor includes a neural network accelerator.

Example 17 can include, or can optionally be combined with the subject matter of Example 15, to optionally include that the machine learning model is quantized for embedded deployment on the processor.

Example 18 can include, or can optionally be combined with the subject matter of Example 15, to optionally include that the machine learning model includes an autoencoder neural network, and that the loss includes a reconstruction loss.

Example 19 can include, or can optionally be combined with the subject matter of Example 18, to optionally include that the autoencoder neural network includes an encoder portion configured to compress the time series representation into a latent representation and a decoder portion configured to reconstruct the time series representation from the latent representation as the output time series representation.

Example 20 can include, or can optionally be combined with the subject matter of Example 19, to optionally include that the encoder portion or the decoder portion includes fully-connected layers.

Example 21 can include, or can optionally be combined with the subject matter of Example 19, to optionally include that the encoder portion or the decoder portion includes a convolutional topology.

Example 22 can include, or can optionally be combined with the subject matter of Example 18, to optionally include that the reconstruction loss includes a mean squared error between the time series representation of the captured analog electrical waveform and the output time series representation.

Example 23 can include, or can optionally be combined with the subject matter of Example 18, to optionally include that the processor is configured to determine whether the integrated circuit device is anomalous by comparing the reconstruction loss to a threshold.

Example 24 can include, or can optionally be combined with the subject matter of Example 23, to optionally include that the processor is configured to determine the integrated circuit device is anomalous when the reconstruction loss is at or above a specified threshold.

Example 25 can include, or can optionally be combined with the subject matter of Example 15, to optionally include that the operational event includes a power-up event, a power-on-reset event, or a memory write event.

Example 26 can include, or can optionally be combined with the subject matter of Example 15, to optionally include that the analog electrical waveform includes a voltage waveform or a current waveform.

Example 27 can include, or can optionally be combined with the subject matter of Example 15, to optionally include that the integrated circuit device includes a communication node, a power node, or a combined communication and power node, and where the analog-to-digital converter is configured to capture the analog electrical waveform by digitizing a signal associated with the communication node, the power node, or the combined communication and power node.

Example 28 can include, or can optionally be combined with the subject matter of Example 15, to optionally include that the controller circuit is configured to capture a second analog electrical waveform from the integrated circuit device during another operational event different from a first operational event, and where the processor is configured to apply a second time series representation of the second analog electrical waveform to another channel of the machine learning model, the machine learning model including a dual-channel or multi-channel architecture.

Example 29 can include, or can optionally be combined with the subject matter of Example 15, to optionally include that the reference integrated circuit devices represent genuine devices, and where the loss indicative that the integrated circuit device is anomalous is with respect to device authenticity.

Example 30 can include, or can optionally be combined with the subject matter of Example 15, to optionally include that the reference integrated circuit devices represent nominal or new devices, and where the loss indicative that the integrated circuit device is anomalous is with respect to device aging status or device electrical stress condition.

Example 31 can include, or can optionally be combined with the subject matter of one or any combination of Examples 1 through 30 to include, subject matter (such as an apparatus, a method, a means for performing acts, or a machine-readable medium including instructions that, when performed by the machine, can cause the machine to perform acts), such as can include a machine-implemented method for training an anomaly detection model for integrated circuit devices, the method including generating time series representations of analog electrical waveforms corresponding to a plurality of reference integrated circuit devices and associated operational events, and training a machine learning model using the time series representations to generate output time series representations including reducing or minimizing a loss between the time series representations and the output time series representations.

Example 32 can include, or can optionally be combined with the subject matter of Example 31, to optionally include that the machine learning model includes an autoencoder neural network, and where the loss includes a reconstruction loss.

Example 33 can include, or can optionally be combined with the subject matter of Example 31, to optionally include that a training dataset includes time series representations corresponding to genuine devices.

Example 34 can include, or can optionally be combined with the subject matter of Example 33, to optionally include determining a normalized separation metric between losses for genuine devices and non-genuine devices in a test dataset.

Example 35 can include, or can optionally be combined with the subject matter of Example 34, to optionally include that the normalized separation metric is calculated as a scaled difference between a maximum loss for a genuine device and a minimum loss for a non-genuine device.

Example 36 can include, or can optionally be combined with the subject matter of Example 35, to optionally include that the scaled difference is scaled by a range defined as the minimum loss for a genuine device and the maximum loss for a non-genuine device.

Example 37 can include, or can optionally be combined with the subject matter of one or any combination of Examples 1 through 36 to include, subject matter (such as an apparatus, a method, a means for performing acts, or a machine-readable medium including instructions that, when performed by the machine, can cause the machine to perform acts), such as can include a machine-implemented method for authenticating integrated circuit devices including capturing an analog electrical waveform from an integrated circuit device during an operational event, applying a time series representation of the captured analog electrical waveform to an encoder neural network to generate an embedding representation, where the encoder neural network was trained using time series representations of analog electrical waveforms captured from reference integrated circuit devices, comparing the embedding representation to a reference embedding representation associated with reference devices, and determining whether the integrated circuit device is anomalous based on a distance metric between the embedding representation and the reference embedding representation.

Example 38 can include, or can optionally be combined with the subject matter of Example 37, to optionally include that the distance metric includes a Euclidean distance.

Example 39 can include, or can optionally be combined with the subject matter of Example 37, to optionally include comparing the embedding representation to the reference embedding representation including calculating the distance metric in a latent space.

Example 40 can include, or can optionally be combined with the subject matter of Example 37, to optionally include that the integrated circuit device is determined to be anomalous when the distance metric is at or above a specified threshold.

Example 41 can include, or can optionally be combined with the subject matter of one or any combination of Examples 1 through 40 to include, subject matter (such as an apparatus, a system, a means for performing acts, or a machine-readable medium including instructions that, when performed by the machine, can cause the machine to perform acts), such as can include a system for authenticating integrated circuit devices including a controller circuit including an analog-to-digital converter circuit configured to capture an analog electrical waveform from an integrated circuit device during an operational event, a processor configured to execute an encoder neural network configured to generate an embedding representation from a time series representation of the captured analog electrical waveform, where the encoder neural network was trained using time series representations of analog electrical waveforms from reference integrated circuit devices, where the processor is configured to compare the embedding representation to a reference embedding representation associated with reference devices, calculate a distance metric between the embedding representation and the reference embedding representation, and determine whether the integrated circuit device is anomalous based on the distance metric.

Example 42 can include, or can optionally be combined with the subject matter of Example 41, to optionally include that the processor is configured to determine the integrated circuit device is anomalous when the distance metric is at or above a specified threshold.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc., are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A machine-implemented method for authenticating integrated circuit devices, the method comprising:
capturing an analog electrical waveform from an integrated circuit device during an operational event;
applying a time series representation of the captured analog electrical waveform to a machine learning model to generate an output time series representation, wherein the machine learning model was trained using time series representations of analog electrical waveforms representative of reference integrated circuit devices;
determining a loss between the time series representation of the captured analog electrical waveform and the output time series representation; and
determining whether the integrated circuit device is anomalous based on the loss.

2. The machine-implemented method of claim 1, wherein the machine learning model comprises an autoencoder neural network; and
wherein the loss comprises a reconstruction loss.

3. The machine-implemented method of claim 2, wherein the autoencoder neural network comprises an encoder portion configured to compress the time series representation into a latent representation and a decoder portion configured to reconstruct the time series representation from the latent representation as the output time series representation.

4. The machine-implemented method of claim 2, wherein the reconstruction loss comprises a mean squared error between the time series representation of the captured analog electrical waveform and the output time series representation.

5. The machine-implemented method of claim 2, wherein determining whether the integrated circuit device is anomalous based on the loss comprises comparing the reconstruction loss to a threshold.

6. The machine-implemented method of claim 1, comprising:
capturing a second analog electrical waveform from the integrated circuit during another operational event different from a first operational event; and
processing a second time series representation of the second analog electrical waveform using another channel of the machine learning model, the machine learning model comprising a dual-channel or multi-channel architecture.

7. The machine-implemented method of claim 1, wherein the reference integrated circuit devices represent genuine devices; and
wherein the loss indicative that the integrated circuit device is anomalous is with respect to device authenticity.

8. The machine-implemented method of claim 1, wherein the reference integrated circuit devices represent nominal or new devices; and
wherein the loss indicative that the integrated circuit device is anomalous is with respect to device aging status or device electrical stress condition.

9. A system for authenticating integrated circuit devices comprising:
a controller circuit including an analog-to-digital converter circuit configured to capture an analog electrical waveform from an integrated circuit device during an operational event;
a processor configured to:
apply a time series representation of the captured analog electrical waveform to a machine learning model to generate an output time series representation;
determine a loss between the time series representation and the output time series representation; and
determine whether the integrated circuit device is anomalous based on the loss;
wherein the machine learning model was trained using time series representations of analog electrical waveforms representative of reference integrated circuit devices.

10. The system of claim 9, wherein the processor comprises a neural network accelerator.

11. The system of claim 9, wherein the machine learning model is quantized for embedded deployment on the processor.

12. The system of claim 9, wherein the machine learning model comprises an autoencoder neural network; and
wherein the loss comprises a reconstruction loss.

13. The system of claim 12, wherein the autoencoder neural network comprises an encoder portion configured to compress the time series representation into a latent representation and a decoder portion configured to reconstruct the time series representation from the latent representation as the output time series representation.

14. The system of claim 12, wherein the reconstruction loss comprises a mean squared error between the time series representation of the captured analog electrical waveform and the output time series representation.

15. The system of claim 12, wherein the processor is configured to determine whether the integrated circuit device is anomalous by comparing the reconstruction loss to a threshold.

16. The system of claim 9, wherein the controller circuit is configured to capture a second analog electrical waveform from the integrated circuit device during another operational event different from a first operational event; and
wherein the processor is configured to apply a second time series representation of the second analog electrical waveform to another channel of the machine learning model, the machine learning model comprising a dual-channel or multi-channel architecture.

17. The system of claim 9, wherein the reference integrated circuit devices represent genuine devices; and
wherein the loss indicative that the integrated circuit device is anomalous is with respect to device authenticity.

18. The system of claim 9, wherein the reference integrated circuit devices represent nominal or new devices; and
wherein the loss indicative that the integrated circuit device is anomalous is with respect to device aging status or device electrical stress condition.

19. A machine-implemented method for training an anomaly detection model for integrated circuit devices, the method comprising:
generating time series representations of analog electrical waveforms corresponding to a plurality of reference integrated circuit devices and associated operational events; and
training a machine learning model using the time series representations to generate output time series representations including reducing or minimizing a loss between the time series representations and the output time series representations.

20. The machine-implemented method of claim 19, wherein the machine learning model comprises an autoencoder neural network; and
wherein the loss comprises a reconstruction loss.
